(19) United States
(12) Patent Application Publication
(10) Pub. No.: US 2009/0304395 A1
(43) Pub. Date: Dec. 10, 2009

(54) Tunable Electrical Return-to-Zero Modulation Method and Apparatus

(76) Inventors: Jin Hong, Saratoga, CA (US); Song Shang, Polo Alto, CA (US)

Correspondence Address: Jin Hong, 19796 Bonnie Ridge Way, Saratoga, CA, 95070, US

(21) Appl. No.: 12/133,373

(22) Filed: Jun. 5, 2008

(51) Int. Cl. H04B 10/04

(52) U.S. Cl. 398/189

(57) ABSTRACT

A tunable duty cycle electrical return-to-zero (RZ) modulation method is realized through tuning of some electrical parameters of an encoder without the need for expensive and/or bulky optical pulse carver, therefore providing a universal RZ apparatus suitable for various high speed applications such as at 10 Gb/s, 40 Gb/s and 100 Gb/s. The electrical RZ modulation scheme is readily combined with other known modulation technologies on the transmitter side to support low cost RZ modulation for metro, long haul and submarine systems.

This U.S. application Ser. No. 12/133,373 is the official continuation filing of the previously filed provisional U.S. Patent Application No. 60/933,077, filed on Jun. 4, 2007, entitled “Tunable duty cycle universal electrical return-to-zero (TDC-ERZ) modulation method and apparatus for low cost optical communication”, therefore claims the priority date of Jun. 4, 2007 of the provisional application U.S. 60/933,077, which is incorporated herein by reference.

### FIELD OF INVENTION

The invention relates to an optical communication system with a return-to-zero (RZ) modulation, and particularly to a method and apparatus generating a widely tunable duty cycle RZ pulse data stream through electrical means without the need for expensive and/or bulky optical RZ pulse carver. The invention provides means to a low cost, small form factor, high performance optical system with great flexibility to support various transmission applications.

### BACKGROUND OF THE INVENTION

Optical fiber transmission systems are subject to distortion related to loss, noise, and nonlinearities in both the fiber and the modulation and amplification devices. One of the deleterious forms of signal distortion is that due-to fiber nonlinearities and polarization mode dispersion (PMD). The main attraction of the retuen-to-zero (RZ) modulation is its demonstrated improved immunity to fiber nonlinearities and PMD relative to non return-to-zero (NRZ) modulation.

The RZ format is being used in commercial 10 Gb/s ultra long haul systems, see P. Hoffman, E. B. Basch, S. Gringeri, R. Egorov, D. Fishman, and W. Thompson, “DWDM long haul network deployment for the Verizon nationwide network,” presented at the OFC 2005, Anaheim, Calif., Paper OtuP5. For 40 Gb/s systems, the addition of phase modulation to the RZ format reduces intra-channel nonlinear effects, see S. Appathurai, V. Mikhailov, R. I. Killey, and P. Batvel, “Investigation of the optimum alternative-phase RZ modulation format and its effectiveness in the suppression of intra-channel nonlinear distortion in 40 Gb/s transmission over the standard single mode fiber,” IEEE J. Sel. Topics Quantum Electron., vol. 10, no. 2, pp. 239-249, March-April 2004. Those RZ techniques, variously referred to as alternative phase RZ (AP-RZ) or carrier suppressed RZ (CS-RZ) have been successfully used in early 40 Gb/s applications, see D. Chen, T. J. Xia, G. Wellbrock, D. Petersen, S. Y. Park, E. Thoen, C. Burton, J. Zyskynd, S. J. Penticost, and P. Mamyshev, “Long span 10×160 km 40 Gb/s line side, OC-768c client side field trial using hybrid Raman/EDFA amplifiers,” in Proc. ECOC 2005, vol. 1, pp. 15-16.

In other modulation schemes, RZ is also commonly used to improve the system performance. For example, in phase shifted key (PSK) modulation schemes suitable for high bit rate applications such as for 40 Gb/s and 100 Gb/s systems, RZ version of differential phase shift keying (DPSK) and differential quadrature phase shift keying (DQPSK) have been shown to provide improved PMD tolerance and approximately 1 to 2-dB improvement in OSNR sensitivity relative to their current NRZ implementation but also requires more bandwidth, see E. Bert Basch, R. Egorov, S. Gringeri, and S. Elby, “Architectural tradeoffs for reconfigurable dense wavelength-division multiplexing systems,” IEEE J. of Selected Topics in Quantum Electronics, vol. 12, no. 4, July/August 2006.

The two most commonly used techniques to generate optical RZ data streams either employ a sinusoidal driven intensity modulator or an actively mode locked laser, in addition to a NRZ data modulator, see, A. Ougazzaden et al, “40 Gb/s tandem electron-absorption modulator,” in Proc. OFC'01, 2001, Post-deadline paper PD14. Apart from the need for two or more high power RF components, these techniques need the accurate synchronization between the data modulator and the pulse source.

Yet another technique is the use of the a single NRZ driven phase modulator followed by a passive optical delay interferometer, eliminating the need for any synchronization between the two signals and considerably alleviates the requirements on the driver amplifiers, see P. J. Winzer and J. Leuthold, “Return to Zero modulator using a single NRZ drive signal and an optical delay interferometer,” IEEE Photon. Technol. Lett., vol. 13, no. 12, pp. 1298-1300, December 2001

In yet another approach, a variable duty cycle RZ pulse can be generated using cascaded optical modulators, see J. C. Mauro, S. Raghavan, S. Ten, “Generation and system impact of variable duty cycle alpha-RZ pulses,” J. Opt. Commun. Vol. 26, pp. 1015, 2005. This is different from all other RZ pulse generation scheme in that the duty cycle of the pulse is variable. However it is implemented in optical domain and therefore expensive to the systems.

In summary, optical RZ pulses are mostly generated by optical means, and commonly implemented by the separate cascaded Mach-Zehnder modulators driven by an NRZ data stream for one section and a clock pulse carver for the second section. The approach requires precise control of amplitude and phase, as well as separate microwave amplifiers for the two sections. In all cases, RZ format is more complex and costly to implement in its current optical format.

Therefore, due to the advantages RZ has over NRZ modulation, there is a need for cost effective solutions to generate the RZ modulation with less cost, less size, less power and better performance so that it can be more readily integrated into more compact form factors for the transmitters, such as for the small form factor modules for 40 Gb/s and 100 Gb/s.

To the best knowledge of the inventors, there is not any RZ pulse generator that is implemented in pure electrical domain and at the same time has a widely tunable duty cycle. It is therefore the objective of the present invention to generate a tunable duty cycle RZ pulse with a universal electrical means, reducing the size, cost, and increasing the flexibility of the systems to adapt to various applications in metro and long haul networks.

### SUMMARY OF THE INVENTION

This U.S. application Ser. No. 12/133,373 is the official continuation filing of the previously filed provisional U.S. Patent Application No. 60/933,077, filed on Jun. 4, 2007, entitled “Tunable duty cycle universal electrical return-to-zero (TDC-ERZ) modulation method and apparatus for low cost optical communication”, and incorporated herein by reference.

The present invention is an electrical RZ pulse generating method and apparatus that has a widely tunable duty cycle that covers the most desirable duty cycle of 33%, 50% and 67% in the single apparatus for high speed 10 Gb/s, 40 Gb/s and 100 Gb/s signals and low cost RZ modulation.

Briefly, as shown in FIG. 1(a) and FIG. 1(b), a preferred embodiment of the present invention includes an AC coupled dual differential input limiting amplifier with a DC-driven bias tee. The AC coupled dual input ports 103 are drive by the incoming NRZ data 102 and the input clock 101 respectively. The DC bias voltage 110 is used for the continuous adjustment of bias voltage of the limiting amplifier and therefore the resulting duty cycle of the generated RZ pulse. In addition, in FIG. 2(a), FIG. 2(b) and FIG. 2(c), some typical examples are shown for a RZ transmitter with present invention.
1) FIG. 2(a) shows a tunable duty cycle electrical RZ driven optical differential coded binary modulation, where a duobinary encoder 109 is inserted into the NRZ data input port and the output port of the encoder is then connected into the input port 102 of the apparatus, in such a tunable duty cycle optical duo-binary transmitter is obtained, without the use of more expensive optical MZ modulator for RZ modulation, as is normally implemented. The present invention offers more features, functions, flexibilities, but less cost and smaller size.
2) FIG. 2(b) shows a traditional NRZ based optical duobinary (NRZ-ODB) transmitter, where both data and the inverted data (data_bar) are fed into the input ports 101 and 102 of the differential limiting amplifier 105, followed by a duobinary encoder 109 to drive a MZ modulator 107. This is a very simple implementation of NRZ ODB transmitter, using the similar architectural design as those in the design in FIG. 2(a).
3) FIG. 2(c) shows a traditional NRZ transmitter using the same design as in FIG. 2(a) and FIG. 2(b) with differential limiting amplifier 105.

Several other preferred embodiments and some application examples for combining this type of RZ pulse generating apparatus with other modulation formats are also shown in FIG. 3, FIG. 4, and FIG. 5.

In summary, a universal design can be implemented based on the present invention such that not only a widely tunable duty cycle electrical RZ pulse generating apparatus is produced cost effectively, but also, other types of transmitters can also be produced by populating or depopulating the building blocks of present invention (duobinary encoder in this case). All in the same design with some by-pass functions to the encoders.

One of the advantages of the present invention is that it can be used to convert many different modulation formats from other pulse formats such as NRZ to RZ cost effectively, and with smaller size for further package integration. For example, the traditional NRZ modulation, the NRZ duobinary modulation, the optical single side band (OSSB) NRZ modulation, the DPSK modulation, and the DQPSK modulation, can be converted into their corresponding RZ format.

The other advantage is its smaller size of the present invention, since it eliminates some of the bulky and/or expensive optical components, such as LiNbO3 or InP Mach-Zehnder modulator. Because of this, many transmitters that employs RZ format can be integrated into the small form factor modules or XFP pluggable package for 10 Gb/s, 40 Gb/s and 100 Gb/s applications.

The other advantage of the present invention is its widely tunable duty cycle, which is suitable for many different applications, such as for metro, long haul, and submarine optical transmission systems due to the needs for different duty cycles.

The other advantage of the present invention is its unique implementation, which produces nearly identical RZ pulse with zero chirps, compared with the optical RZ pulse generation for high speed transmitters.

These and other objects and advantages of the present invention will no doubt become obvious to those of ordinary skill in the art after having read the following detailed description of the best mode operations.

### BRIEF DESCRIPTION OF THE DRAWING

The invention will now be described in great details with reference to the drawings, in which

FIG. 1 is one of the preferred embodiments of the present invention for transmitter with tunable duty cycle electrical RZ modulation (ERZ).

FIG. 2: Several other preferred embodiments and application examples for combining the present invention with other modulation formats.

FIG. 2(a): Tunable duty cycle electrical RZ (ERZ) driven optical differential coded binary modulation (this invention)

FIG. 2(b): Tunable duty cycle electrical RZ (ERZ) transmitter with also electrical duobinary modulation (DB) generation.

FIG. 2(c): Tunable duty cycle electrical RZ transmitter (ERZ).

FIG. 3: One of the embodiments of electrical based RZ-DPSK and electrical RZ-DQPSK utilizing the present invention in the electrical domain to remove the need for expensive and/or bulky optical RZ pulse carver such as MZ modulator in their traditional optical domain implementation.

FIG. 4: One of the embodiments for NRZ-DQPSK transmitter using single MZ modulator with dual drive in order to further reduce the cost of DQPSK transmitter implementation, in addition to the benefit resulting from the present invention as shown in FIG. 1. The implementation of DQPSK itself is also further simplified utilizing a single MZ modulator with dual electrical drive, instead of the two parallel MZ modulators.

FIG. 5: One of the embodiments for electrical RZ-DQPSK transmitter using single MZ modulator with dual drive in order to reduce the cost of RZ-DQPSK transmitter implementation. The present invention as shown in FIG. 1 is used to produce electrical RZ-DQPSK transmitter.

### DESCRIPTION OF PREFERRED EMBODIMENTS

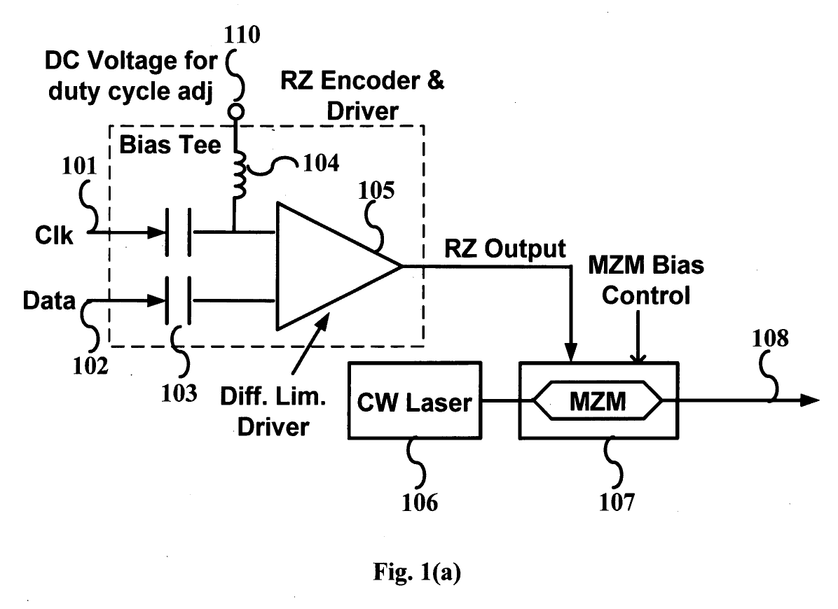

Accordingly to one of the preferred embodiments of the present invention, a tunable duty cycle electrical RZ pulse generating apparatus to convert NRZ data stream to RZ data stream is shown in FIG. 1(a) and FIG. 1(b). The incoming NRZ data input 102 and the clock input 101 are both fed through AC coupling 103, into the electrical RZ (ERZ) encoder and driver, which is made of a differential limiting amplifier 105 and a Bias Tee 104 for the limiting amplifier. The DC voltage 110 of the Bias-Tee 104 can be used as the single parameter to adjust the RZ pulse duty cycle as shown in the diagram in FIG. 1(b). The different limiting amplifier 105 is driven by the NRZ data 102 and the associated clock 101, therefore generates a RZ pulse output with a tunable duty cycle based on the Bias Tee 103's DC bias voltage 110, which can be continuously fine tuned. FIG. 1(b) shows the input NRZ data stream, the input clock, and the DC bias on the Bias-Tee, and the resulting electrical RS pulse stream. The benefits of this implementation are multi-folded. Firstly, a single RF driver to provide RZ encoding and RZ pulse amplification is needed. There is no need for a 2nd MZ modulator and clock driver for RZ pulse generation in optical domain. Secondly, comparing to the conventional RZ generation, the high-speed AND gate can be removed, which results in further power and cost reduction. Thirdly, using a simple bias-tee and DC offset for the input clock, the duty cycle of the RZ data can be adjusted by greater than ±15% from its default 50% value. Thus this RZ transmitter design is also capable for submarine (33% duty cycle) and terrestrial ultra-long haul, e.g. CSRZ (67%) application. Fourthly, this scheme can be combined with differential encoder to be used for RZ-DPSK applications.

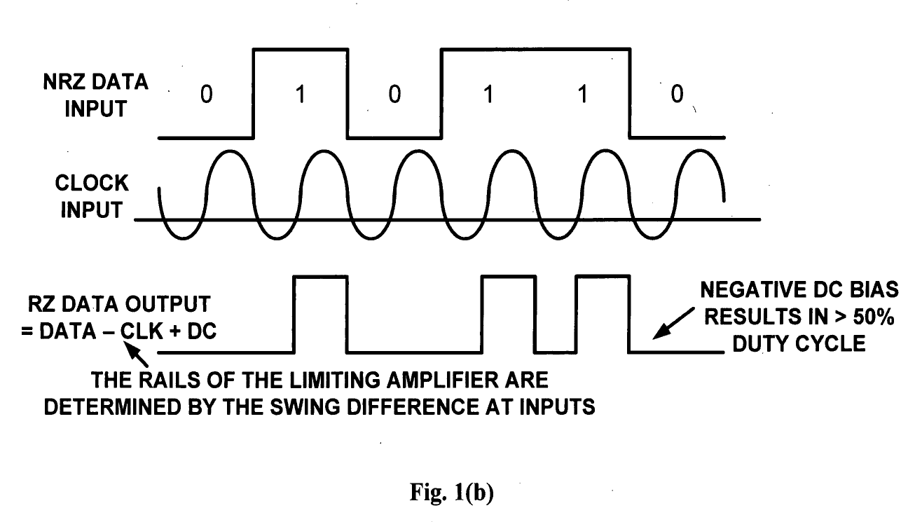

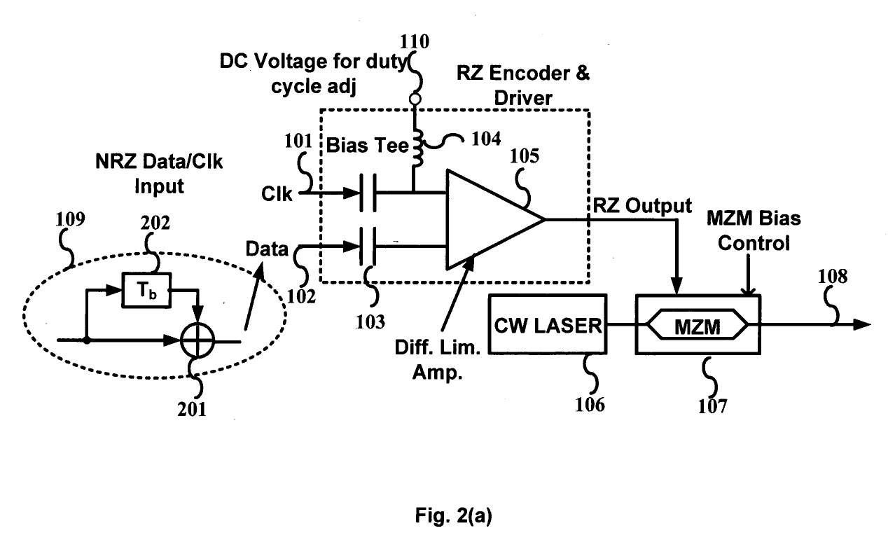

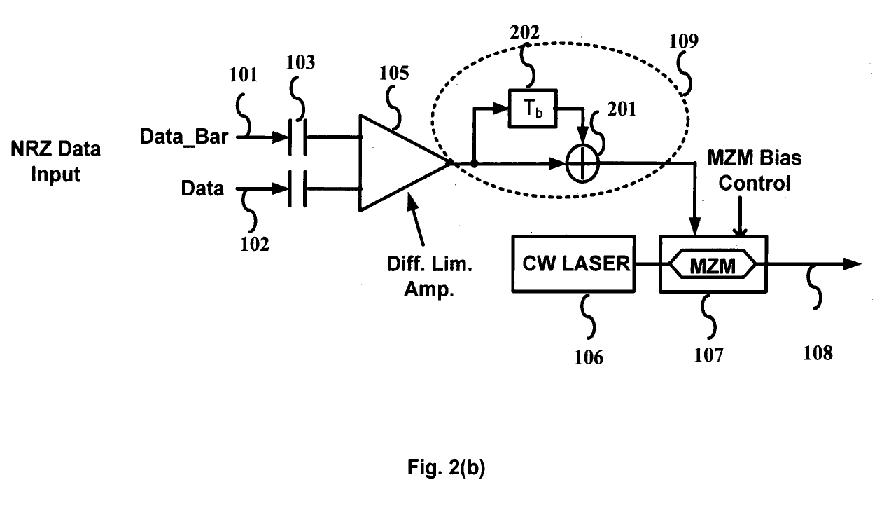

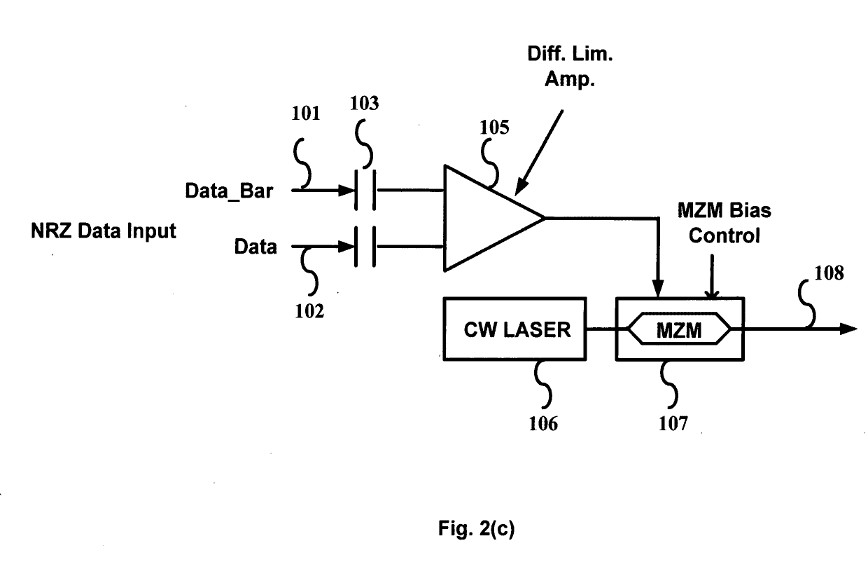

According to one of the other embodiments, several preferred implementations and applications for, combining the present invention with other modulation formats are shown in FIG. 2. As shown in FIG. 2(a), a tunable duty cycle electrical RZ driven optical differential coded binary modulation is presented based on the current invention, where an duobinary encoder 109 is inserted into the NRZ data input port and the output port of the encoder is then connected into the input port 102 of the data input port, in such a tunable duty cycle RZ duobinary transmitter is obtained, without the use of more expensive optical MZ modulator, as is normally implemented. The present invention offers more features, functions, flexibilities, but less cost and smaller size. The encoder portion is a typical data pass summed up with its one-bit delay line (the delay time can be optimized to be less or more than one bit period) with the use of exclusive OR gate logic (XOR gate), or a FIR filter (finite impulse response filter), or a FFE based EDC (electrical dispersion compensator) chip with 3 taps and each tap has a half bit period of delay. As shown in FIG. 2(b), a tunable duty cycle transmitter with an electrical RZ modulation and also an electrical duobinary signal encoding is presented, where both data and the inverted data (data_bar) are fed into the input ports 101 and 102 of the differential limiting amplifier, followed by an electrical duobinary encoder (also the present invention) to drive a MZ modulator. This is a very simple implementation of RZ duobinary transmitter, using the similar architectural design as those in the design in FIG. 2(a). As shown in FIG. 2(c), a tunable duty cycle transmitter with electrical RZ modulation, but without the duobinary encoding is presented using the same design with differential limiting amplifier. In summary, a universal design is implemented based on the present invention such that not only a widely tunable duty cycle electrical RZ pulse generating apparatus is produced cost effectively, but also, other types of transmitters can be produced by populating or depopulating the building blocks (pre-coder and en-coder in this case) in the same design with some by-pass functions to the pre-coders/encoder 109 placed either in the NRZ data incoming path right before the input to the AC coupling port 104 of the differential limiting amplifier 105, or right after the output of the differential limiting amplifier 105.

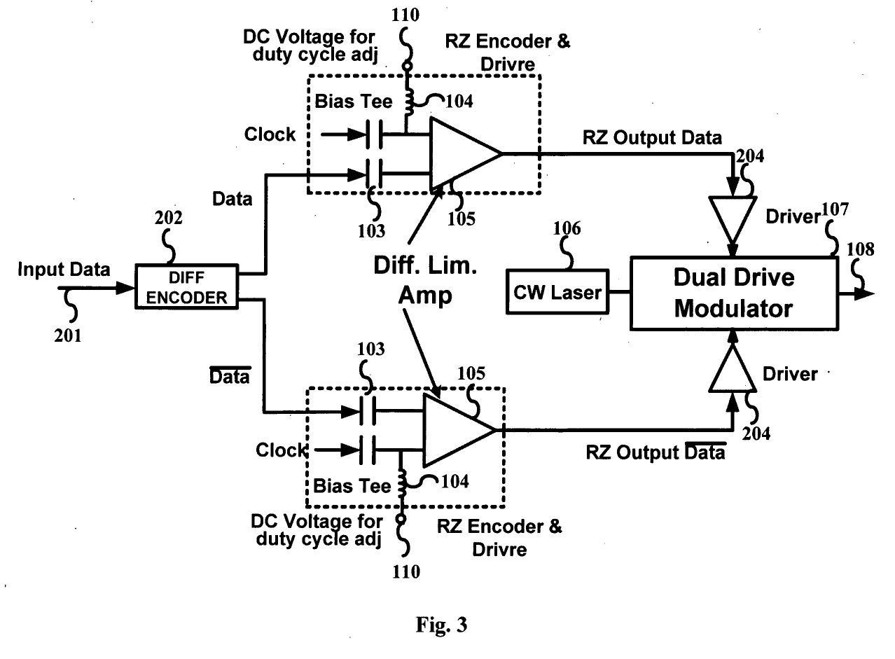

According to another embodiment of the present invention, an electrical RZ-DPSK transmitter and an electrical RZ-DQPSK transmitter utilizing the present invention in the electrical domain to remove the need for expensive and/or bulky optical RZ pulse carver such as MZ modulator in their traditional optical domain implementation is shown in FIG. 3. For electrical RZ-DPSK, instead of using NRZ “Data” and “Data_Bar” to drive the first MZ modulator, the embodiment as shown in FIG. 1 is used to generate two output RZ pulse streams of the respective differential limiting amplifiers from individual “Data” signal and “Data_Bar” signal sampled and limited by the input NRZ clock, to drive the first MZ modulator. Since the resulting pulse is now an optical RZ stream, there is no need for the second MZ modulator as the RZ pulse carver and therefore, it can be removed. In this case, the MZ modulator can be the standard MZ normally used for DPSK modulation. It can also be the dual drive MZ modulator designed for DQPSK modulation. For the electrical RZ-DQPSK transmitter, similarly, instead of using NRZ “Data” and “Data1” to drive the two parallel MZ modulators, the embodiment as shown in FIG. 1 is used to generate two output RZ pulse streams of the respective differential limiting amplifiers 105 from individual “Data” signal and “Data1” signal sampled and limited by the input NRZ clock, to drive the first two MZ modulators in parallel. Since the resulting pulse stream is now an optical RZ stream, there is no need for the third MZ modulator cascaded after as the RZ pulse carver and therefore, it can be removed.

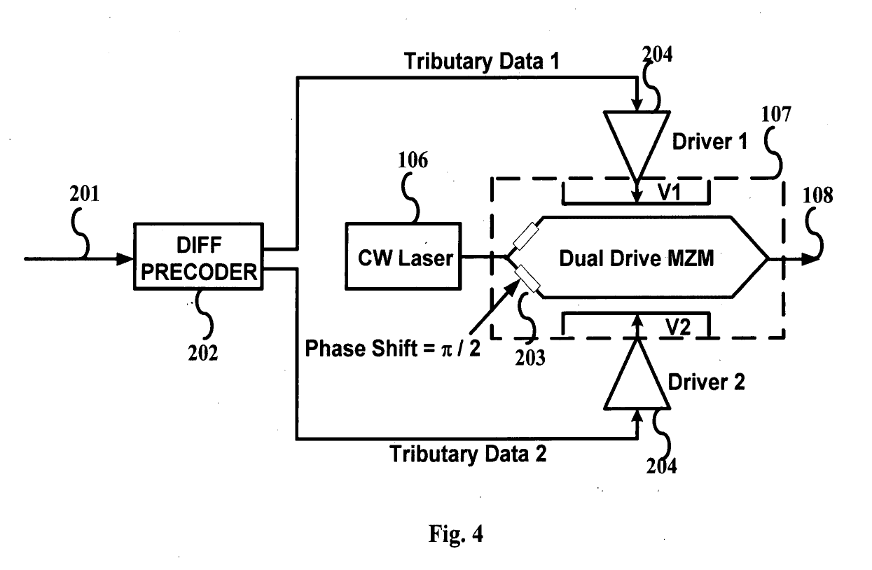

According to another embodiment of the present invention, a NRZ-DQPSK transmitter using single MZ modulator with dual drive is shown in FIG. 4. In order to further reduce the cost of DQPSK transmitter implementation, in addition to the benefit resulting from the present invention as shown in FIG. 1, the implementation of DQPSK itself can also be further simplified utilizing a single MZ modulator with dual electrical drive, instead of the two parallel-MZ modulators. The diagram is shown for the preferred embodiment for low cost DQPSK modulator, where a single MZ modulator is used. Firstly, the differential pre-coder 202 is used convert the input data stream into two tributary data stream “Data1” and “Data2”. Then each of the data streams is used to drive independently one of the arms of the single MZ modulator with its own bias voltage. In each of the MZ modulator arms, there is an independent phase control section that can be used to set the phase delay in each of the arms independently. Normally, for DQPSK application, the phase in one arm is set to zero and in another is set to 90 degrees. If the input data into the pre-coder is the NRZ stream, and then this embodiment of DQPSK is the NRZ-DQPSK. It has the advantage over traditional implementation that it reduces the cost, size, power consumption, and therefore allows for the integration into a much smaller package, such as XFP and small form factor modules. This implementation is flexible and versatile in that the two independent drives into the MZ modulator arms can be of various amplitude and phase relationship in order to produce various types of phase or amplitude modulation formats. The details will not be discussed here, but anyone with ordinary skills can derive obvious alterations based on this.

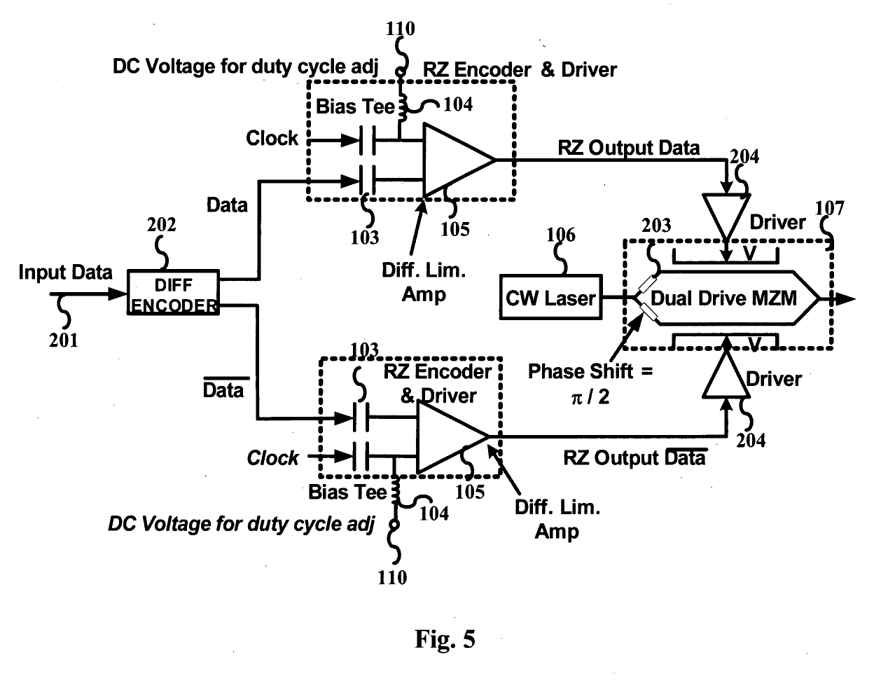

According to another embodiment of the present invention, an electrical RZ-DQPSK transmitter using single MZ modulator with dual drive is shown in FIG. 5.

In order to further reduce the cost of RZ-DQPSK transmitter implementation, the present invention as shown in FIG. 1 is used to produce an electrical RZ-DQPSK transmitter. Firstly, the differential pre-coder is used to convert the input data stream into two tributary data stream “Data1” and “Data2”. Then each of the data streams is then paired with the input clock signal to feed into one AC-coupled differential limiting amplifier 105 to produce the electrical RZ pulse stream based on the input data stream “Data1” or “Data2”. The bias voltage 110 of the two limiting amplifiers 105 are set as the same in order to produce the same output ERZ pulse duty cycle for input data stream“Data1” and “Data2”. The two output electrical RZ pulse streams from the two limiting amplifiers are then fed into the single dual drive MZ modulator 107 to drive the two arms independently. In each of the MZ modulator arms, there is an independent phase control section that can be used to set the phase delay in each of the arms independently. Normally, for DQPSK application, the phase in one arm is set to zero and in another is set to 90 degrees. This type of electrical RZ-DQPSK transmitter has the advantage that it is much simpler in design, smaller in size, much less expensive in cost, and offers similar or better performance, and can be easily integrated into a much smaller package, such as XFP and small form factor package, which cannot be achieved currently with the exiting solutions due to its bulky size and need of more optical components.

Although the present invention has been described in terms of the presently preferred embodiments, it is to be understood that such disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the present invention.

What is claimed is:

1. A tunable duty cycle universal electrical RZ pulse stream modulation method and apparatus, comprising: a) the use of the both data and clock from the NRZ put data stream to drive the differential input and of the differential limiting amplifier, and both inputs are through the AC coupling, the use of a bias tee to the differential limiting amplifier, where the adjustable bias voltage is used to adjust the bias voltage and therefore the resulting duty cycle of the output ERZ pulse stream through the clipping function of the limiting amplifier; c) the use of the differential limiting amplifier as the basis of the electrical RZ pulse generating apparatus. RF driver can be part of the apparatus as well for the driving of the external Mach-Zehnder (MZ) modulator.

2. The method and apparatus of claim 1, wherein: the tunable duty cycle range covers 33%, 50% and 67%, and is either discretely, piecewise, or continuously tunable through the adjustment of the controlling parameters (in this particular embodiment, the adjustment of bias voltage of the differential limiting amplifier); therefore one method and apparatus is suitable for multiple applications where the different duty cycles are required.

3. The method and apparatus of claim 1, wherein: if the parameter is optionally fixed for certain specific applications, the present invention is used optionally as the fixed duty cycle electrical RZ pulse stream generator, which may further reduce the implementation cost for the need of a fixed duty cycle in a group of specific applications.

4. The method and apparatus of claim 1, wherein: the electrical RZ generation is optionally integrated with the RF amplifier to drive the data encoding devices, such as the Mach-Zehnder modulators, with either single drive, or dual drive circuits.

5. The method and apparatus of claim 1, wherein: it is optionally used to drive a single MZ modulator to form a binary RZ optical modulation transmitter for the transmission systems.

6. The method and apparatus of claim 1, wherein: it is optionally combined with the duobinary pre-coder and encoder to form a RZ version of duobinary optical modulation transmitter for the transmission systems.

7. The method and apparatus of claim 1, wherein: it is optionally combined with the optical single side band (OSSB) NRZ modulator to form a RZ version of OSSB modulation transmitter for the transmission systems.

8. The method and apparatus of claim 1, wherein: it is optionally combined with a NRZ PSK modulator to form an electrical RZ-DPSK, an electrical RZ-DQPSK, an electrical RZ-QPSK, or an electrical multiple level PSK modulation based transmitter for the transmission systems.

9. The method and apparatus of claim 1, wherein: it is optionally combined with other types of NRZ modulators such as those involving in multi amplitude levels, or multi phase levels, or different polarization levels, or a combination of some of them, to form a RZ version of similar types of modulation transmitter for the transmission systems.

10. The method and apparatus of claim 1, wherein: it is optionally combined with any types of NRZ modulators to convert NRZ pulse streams to RZ pulse streams on the transmitter, and/or with electrical three level encoder to produce a three level optical signal, and then detected and decoded by the electrical three level (electrical duobinary: EDB) receivers to form a very cost effective ERZ and/or an EDB based transmitter, with an EDB based receiver pair in the optical transmission system for high speed applications.

11. The method and apparatus of claim 1, wherein: it is optionally reduced to a conventional NRZ transmitter, if the bias tee is omitted and there is no duobinary pre-coder in the NRZ data input path or in the output path of limiting amplifier, and the clock input is replaced by the inverted NRZ data input.

12. The method and apparatus of claim 1, wherein: it is optionally reduced to a conventional NRZ optical duobinary transmitter, if the bias tee is omitted and there is one duobinary pre-coder/encoder in the output path of limiting amplifier, and also the clock input is replaced by the inverted NRZ data input.

13. The method and apparatus of claim 1, wherein: it is optionally used as a RZ optical duobinary transmitter, if there is one duobinary pre-coder/encoder between the input NRZ data and one of the input ports of the AC coupled limiting amplifier.
